(19) United States
(12) Patent Application Publication
(10) Pub. No.: US 2022/0373123 A1
(43) Pub. Date: Nov. 24, 2022

(54) REMOTELY OPERATED HORIZONTAL PIG LAUNCHER

(71) Applicant: VETCO GRAY SCANDINAVIA AS, Nailsea (GB)

(72) Inventors: Steinar Lindemann HESTETUN, Hovik, Akershus (NO); Jon GUNDERSRUD, Hovik, Akershus (NO); Ole Bjorn HJORTH-JOHANSEN, Hovik, Akershus (NO)

(21) Appl. No.: 17/755,300

(22) PCT Filed: Oct. 26, 2020
(86) PCT No.: PCT/EP2020/025475

§ 371 Date: Apr. 26, 2022

(30) Foreign Application Priority Data
Oct. 31, 2019 (NO) 20191305

(51) Int. Cl. F16L 55/46; B08B 9/055

(52) U.S. Cl. CPC F16L 55/46; B08B 9/0551; B08B 2209/055

(57) ABSTRACT

The present invention concerns a pig launcher comprising a tubular pig housing holding several pigs in line. A main connector is connectable to a fluid flow line at an end of the tubular pig housing. A kicker valve is provided for each pig and includes a control pressure inlet, a flow inlet and a flow outlet. A kicker valve control pipe is connected each of the kicker valves and to a kicker system connector. A kicker header is connected to the flow inlet of each of the kicker valves. A kicker branch pipe is connected between each of the kicker valves and the kicker branch pipe inlet for each of the number of pigs.

The present invention relates to subsea Remotely Operated Pig Launchers (ROPL) with a pig magazine, a launcher mechanism and a connector suitable for connecting the pig launcher to a fluid flow line and a Subsea Control Module (SCM). The pig launcher is releasable, connected to a fluid flow line and remotely operated or controlled.

Hydrocarbon fluids are transported through pipelines over substantial distances from a reservoir to a destination such as a floating production unit, a refinery or a depot. When the hydrocarbon fluids emerge from subterranean reservoirs, the temperature is high, and deposits do not present a problem. However, as temperature sink during transport away from the reservoir, the transported fluid leave deposits on the pipe walls. There is a continuous need for removal of such deposits. There is also a need for monitoring and surveillance of pipelines to ensure that damages or other potentially harmful incidents are detected. A pig introduced into a fluid flow close to the hydrocarbon wells performs the removal and surveillance operations. The pig is entrained in a fluid flow through the pipes to be cleaned or monitored and to a recovery station, normally at the end of the pipe lines e.g. at a floating production unit, a refinery or a depot. The pig is then retrieved, undergo maintenance and can be reused.

In some subsea fields, the launching point for the pig is at a distance from the field and a pig is launched manually or by means of a tool. In these fields, the pig can be led through a dual pipeline down to the field. Pigging loops at the field connect the two production lines and the pig returns to the launching point.

Another solution is to arrange a magazine with pigs at an end section of a production pipe, often in connection with a production manifold, a Pipeline End Termination, (PLET) or a Pipeline End Manifold (PLEM). In this solution, pigs are launched by a remotely operated launching mechanism, one by one as needed. The pig magazine includes a limited number of pigs. When the magazine is empty, it is replaced with a filled-up magazine.

Some automated pig launcher systems are large standalone modules that require a separate foundation, an additional jumper arrangement to be hooked up to the production system, kicker fluid jumpers, a hydraulic supply and electrical control/communication systems.

It is an object of the present invention to present a simplified remotely operated pig launcher.

The pig launcher of the present invention includes a pig launcher with a pig magazine, a launcher mechanism and a connection system with a main bore hub and a multi bore kicker hub for kicker fluid and control fluid connected to the future end of a production manifold, PLET or PLEM. The future end is the end of the manifold not connected to pipelines. The pig launcher utilizes the existing control and injection system already existing on the production manifold, PLET or PLEM. The direct connection system of the invention eliminates the requirement for additional jumpers or flying leads.

The pig launcher of the present invention is suitable when pigging requirements demand frequent use of utility pigs for wax deposit removal (initiated by manual command). The pig launcher may be retrieved to the surface when empty for reloading topside.

The present invention thus concerns a pig launcher with a tubular pig housing adapted to hold a number of pigs arranged in a line. The tubular pig housing includes a kicker branch pipe inlet for each of the number of pigs spaced along a longitudinal axis of the tubular pig housing. A main connector connectable to a fluid flow line is located at an end of the tubular pig housing. A kicker valve is provided for each of the number of pigs, each kicker valve including a control pressure inlet, a flow inlet and a flow outlet. A kicker valve control pipe is connected to the control pressure inlet on each of the kicker valves and to a kicker system connector. A kicker header is connected to the flow inlet of each of the kicker valves. A kicker branch pipe is connected between the flow outlet of each of the kicker valves and the kicker branch pipe inlet for each of the number of pigs.

Each kicker valve control pipe may be connected to one single kicker system connector for all the kicker valve control pipes.

The kicker header may be connected to the kicker system connector.

The pig launcher may further include a bypass branch with a bypass valve between an inlet end of the kicker header and an outlet end of the tubular pig housing.

The kicker system connector may include a fluid coupler with a poppet valve for each of the kicker valve control pipes.

The pig launcher may further include a kicker connector hub saver with a hub connector at a first end connected to the kicker system connector and a kicker system hub saver hub at a second end.

The kicker connector hub saver may include a fluid coupler with a poppet valve for each of the kicker valve control pipes on at least one of the first end and the second end.

The pig launcher may further include a main connector hub saver with a hub connector at a first end connected to the main connector and a main connector hub saver hub at a second end.

The pig launcher may further include a pig lock in the pig housing between a connection between a bypass branch and the tubular pig housing, and a connection between the tubular pig housing and a kicker branch pipe.

The number of pigs of the pig housing is adapted to hold may correspond to the number of kicker valves.

The number of pigs the pig housing is adapted to hold, and the number of kicker valves may be six.

The pig launcher may be adapted to be installed on a seabed with a horizontal longitudinal axis of the pig housing.

Furthermore, the present invention concerns a pig launching system with a pig launcher as described above, further including a subsea control module (SCM) with a fluid port for each of the kicker valve control pipes in fluid connection with the kicker system connector.

Furthermore, the present invention concerns use of a pig launcher as described above to launch at least one pig into a fluid flow containing pipeline.

### SHORT DESCRIPTION OF THE ENCLOSED DRAWINGS

FIG. 1 is a is a perspective view of an embodiment of a remotely operated pig launcher of the invention;

FIG. 2 is a side elevation of the embodiment of FIG. 1;

FIG. 3 is a front elevation further showing the features of the embodiment of the remotely controlled pig launcher;

FIG. 4 is a top elevation of the embodiment shown in FIGS. 1-3;

FIG. 5 is a flow chart representing the solution of FIGS. 1-4; and

FIG. 6 is a schematic representation of a subsea, dual header hydrocarbon production manifold connected to two remotely controlled pig launchers as shown in the FIGS. 1-5.

### DETAILED DESCRIPTION OF AN EMBODIMENT OF THE INVENTION WITH REFERENCE TO THE ENCLOSED DRAWINGS

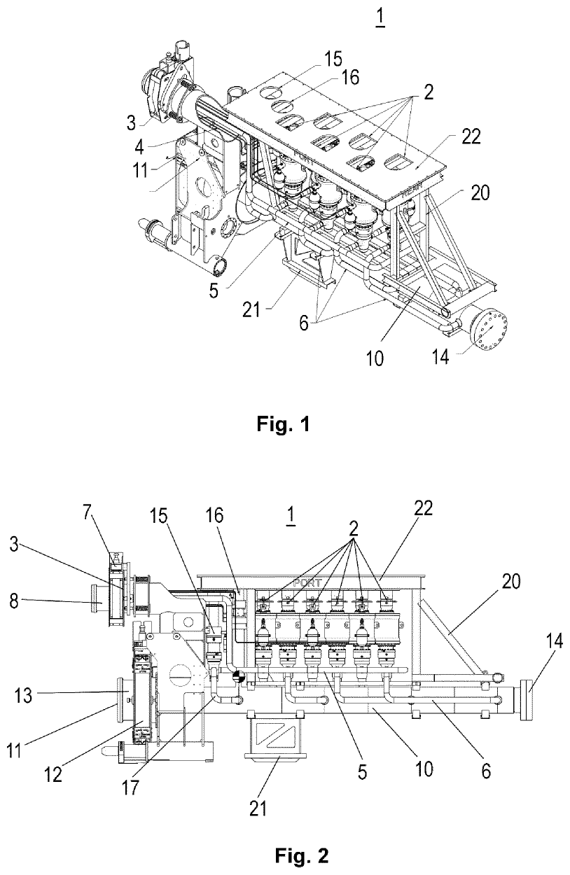

The FIGS. 1-4 are different views of the same embodiment of the pig launcher of the invention and the same reference numerals refer to the same part. Not all the figs. are described with all the reference numerals shown on the figures.

FIG. 1 is a perspective view of an embodiment of a Remotely Operated or controlled Pig Launcher 1 ROPL of the invention. The remotely controlled pig launcher 1 includes six kicker valves 2 in fluid connection with a tubular pig housing or magazine 10 holding up to six pigs. The kicker valves 2 are normally closed pressure operated gate valves and include fail safe closed compensation (FSC) valves with hydraulic actuators, meaning that they will stay closed in the event of a loss of pressure or if pressure is not applied. Each pig is launched upon opening of one of the six kicker valves 2. Each kicker valve 2 is actuated by a pressure signal through a pilot pipe/control line or kicker valve control piping 4 extending through a kicker system connector 3. The kicker system connector 3 includes a multibore hub with fluid couplers each with a poppet valve. The kicker valves 2 include hydraulic actuators.

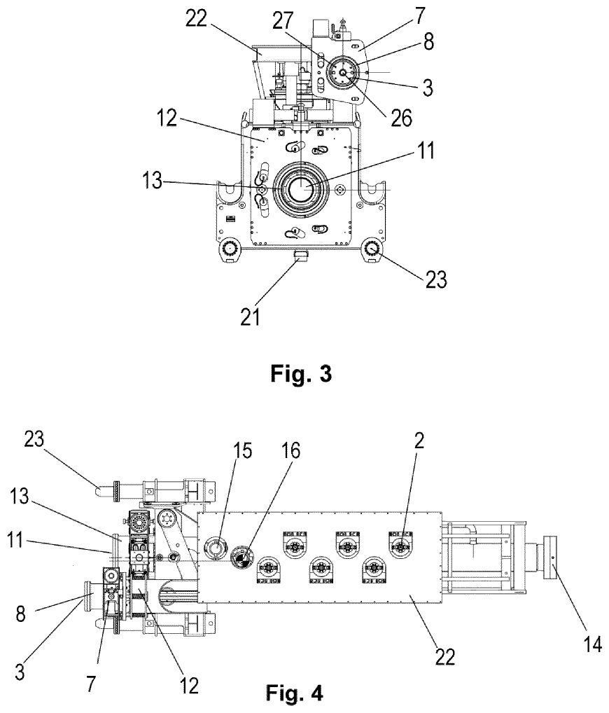

A main frame 20 includes a drop protection 22 with a top plate with openings to gain access to the components below the top plate. The drop protection 22 protect the kicker valves and the other components of the pig launcher from objects dropped from a location above the pig launcher. The main frame 20 also provides a mounting base for the kicker system connector 3, the main connector 11 and the guide pins 21 (FIG. 3). The rear landing foot 23 is centrally located below the pig housing 10.

An ROV operable pig lock 16 typically includes a tool bucket for a tool on an ROV allowing the ROV to unlock the pig lock when the pig launcher is installed in a horizontal position, and is installed to prevent the rack of pigs from moving unintentionally inside the pig housing 10.

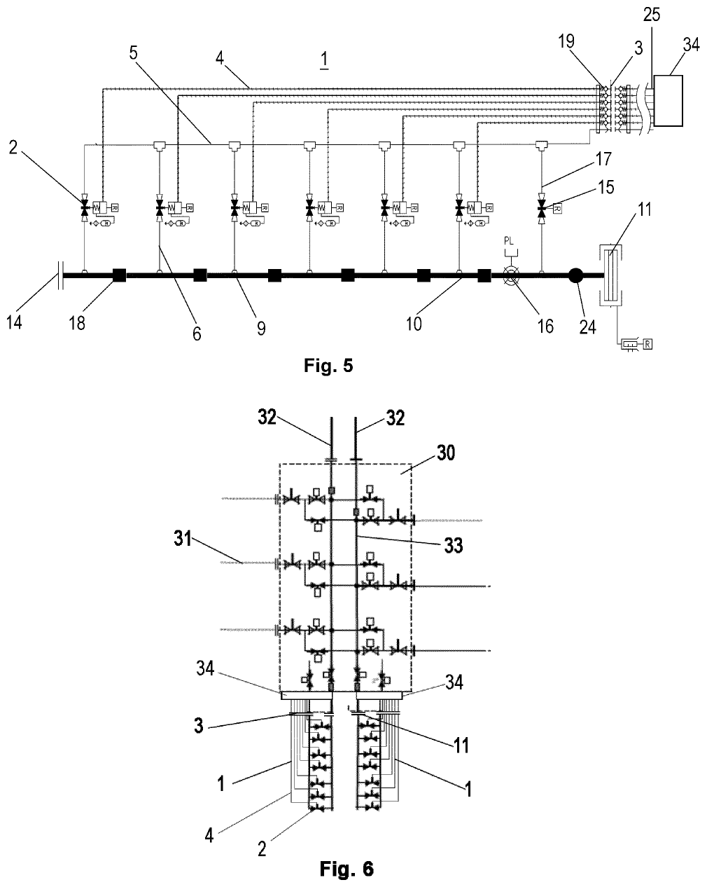

A bypass- or X-over valve 15 and flushing bypass branch 17 (FIG. 5) allows fluid from the host module to flow through the horizontal pig launcher 1 without passing the kicker valves 2 to facilitate flushing of fluid through the launcher and into the pipe. The bypass valve 15 provides fluid from the kicker system connector 3 and into the pig housing 10 to a location in the pig housing 10 between the pigs and the main connector 11 forming an exit for the pigs. The bypass valve 15 allows fluid to be circulated through the pig launcher 1 without having to launch a pig and thus allow flushing of kicker bores and main bores to remove sea water after the ROPL have been connected subsea.

An end closure 14 formed as a detachable cap may be used to reload new pigs into the pig housing 10 at the surface.

Fluid from a host module such as a production manifold, flows through the kicker system connector 3, through a kicker header 5 and into each kicker valve 2. One kicker branch 6 for each pig connects each valve 2 with the tubular pig housing 10 forming a magazine for the pigs. The main connector 11 provides an exit opening for the pigs and for fluid driving the pigs from the kicker hub. The main connector includes a horizontal clamp connection system.

The rear landing foot 21 supports the horizontal remotely controlled pig launcher during installation.

FIG. 2 is a side elevation of the embodiment of FIG. 1 and shows that the kicker system connector 3 is fixed to an exchangeable kicker connector hub saver 8 with a kicker connector clamp 7. The exchangeable kicker connector hub saver 8 includes a kicker system hub saver hub. The kicker system connector 3 is a multiple bore connector and simultaneously connects the pilot pipes for each kicker valve 2, and a kicker header 5 with a host module (not shown) providing control input to the pilot lines/kicker valve control piping and fluid to circulate the pigs. The main connector 11 is fixed to the exchangeable main connector hub saver 13 with a main connector clamp 12 at the same time. The exchangeable main connector hub saver 13 includes a main connector hub saver hub.

The main connector 11 for the main bore of the ROPL may include a horizontal clamp connection system (HCCS) with a back-seal test system. (Typical size for HCCS is 22/720/450). Hydraulic lines in the kicker system connector 3 are pressurized from a Subsea Control Module SCM (34 in FIGS. 5, 6) towards each kicker valve 2 one by one when the ROPL is tested.

The main connector hub saver 13 and the kicker connector hub saver 8 both include a hub and are easy to replace. The hub savers 8, 13 can thus be replaced when they are worn.

The kicker system connector 3 and the main connector 11 also include connector hubs (not shown).

The main frame 20 serves to reinforce the entire structure and may serve to hold various component and ancillaries to the launcher. The header 5 includes six branched off portions supplying fluid entering through the kicker system connector 3 to the six pilot pressure operated kicker valves 2.

The rear landing foot 21 is secured to the pig housing 10 close to the centre of gravity C.G. of the pig launcher. The detachable end closure 14 is seated onto an end flange of the pig housing 10 and allows the pig housing 10 or magazine to be reloaded with pigs in situ or when the pig launcher is retrieved.

FIG. 3 is a front elevation further showing the features of the embodiment of the remotely controlled pig launcher. The pig launcher includes guide pins 23 to facilitate connection of the kicker system connector 3 and the main connector 11 of the pig launcher. The kicker system connector 3 includes kicker piping connections 27 surrounding a centrally located kicker header connection 26. The main connector clamp 12 provides a releasable connection between the main connector sub saver 13 and the main connector hub (not shown). Similarly, the kicker connector clamp 7 provides a releasable connection between the kicker system connector sub saver 8 and the kicker connector hub (not shown).

FIG. 4 is a top elevation further showing the features of the embodiment of the remotely controlled pig launcher. The drop protection 22 includes the access openings to access the kicker valves 2, the pig lock 12 and the bypass valve 15. The openings allows a torque tool on an ROV to actuate the valves and the pig lock. Tool buckets on the valves and openings in the drop protection 22 are included to enable actuation of the valves as a manual override in the event of a failure of the remotely controlled system.

FIG. 5 is a flow chart representing the solution of FIGS. 1-4, showing the six pigs 18 in the magazine/pig housing 10, held in place by the ROV operated pig lock 16. The six pigs 18 can exit through the main connector 11 upon unlocking the pig lock 16 and application of pressure by one of the six kicker valves 2 through the kicker valve branch pipes 6 and the kicker branch pipe inlets 9 in the pig housing 10. Pigs 18 may be replenished through the releasable end closure 14. The kicker system connector 3 includes a fluid coupler with a poppet valve 19 for each hydraulic control line 4.

When all the pigs 18 in the pig housing 10 are launched, the pig launcher may be replaced with a new charged pig launcher, while the empty pig launcher is retrieved. Maintenance is done, and the pig launcher is made ready for use.

A set of pig detectors 24 verify that the pigs are launched and properly caught in the production flow. The pig detectors 24 are arranged at the exit of the pig launcher 1 and at the entry area for entry of the pig in the production flow (not shown). A kicker valve control signal pressure is bled off as soon at the pig 18 has passed the detectors at detection points at the exit of the pig magazine and adjacent to the production flow in the pipeline. A main valve in a manifold will then be closed and the pig launcher is maintained closed until it is time to launch the next pig 18 in line. The subsea control module (SCM) 34 with subsea control module fluid ports 25 is connected to the kicker system connector 3.

The pig launcher can also be provided at other subsea structures, such as pipeline end manifolds (PLEM) or terminations (PLET).

FIG. 6 is a schematic representation of a subsea, dual header hydrocarbon production manifold 30 connected to two remotely controlled pig launchers 1 of the invention and as described above. The manifold 30 includes two manifold headers 33 and is connected to six wellheads through jumpers 31. This manifold layout is used at subsea production fields and the shown pig launchers 1 are applicable to any subsea production field where there is a requirement for pig launching in the field.

The pigs accommodated in the pig housings are pushed out of the housings by control fluid provided through the kicker valves 2 actuated upon hydraulic pressure in the kicker valve control piping 4. Each pig launcher 1 is connected to a subsea control module (SCM) 34 through the kicker system connector 3. (both of the pig launchers may be connected to the same SCM). The SCM 34 provides a hydraulic signal through the kicker system connector 3 to open one of the kicker valves 2 to launch a pig.

In the control system SCM 34 there are six hydraulic actuated valves for the kicker lines that launch the different pigs on the ROPL itself. All other control functions related to pigging are located on the SCM 34 on the manifold.

The manifold mounted subsea control module SCM 34 supplies the pressure for the actuated kicker valves 2 via the kicker system connector 3 forming a multi-bore hub between the ROPL and the manifold.

The hydraulically operated isolation valves on the manifold control production fluid or another kicker fluid, typically Mono-ethylene glycol, MEG to the kicker supply lines. The actuated header valve on the manifold is opened to allow a pig to enter the manifold header and further into the pipeline.

Pig detectors at each end of the manifold header verifies that a pig has left the ROPL, and when the pig has moved past manifold branches and into the pipeline. Kicker line will be flushed, and valves closed.

The manifold 30 is equipped with a hydraulically actuated header valve that is operated to allow pigs to enter the manifold header 33. There are also a number of valves on the manifold to be able to take off production from any of the production branches and route the produced fluids to one of the two ROPLs kicker supply lines. In addition, there are hydraulically actuated isolation valves for flushing the manifold MEG system.

The pig launcher of the present invention utilizes existing functionality in a host structure including the control system, the header valve MEG/Kicker supply, and all lines are connected simultaneously without use of any flying leads or additional jumpers.

| | |
|---|---|
| 1 | Remotely controlled pig launcher |
| 2 | Kicker valves |
| 3 | Kicker system connector |
| 4 | Kicker valve control piping/pilot piping |
| 5 | Kicker header |
| 6 | Kicker branch pipe |
| 7 | Kicker connector clamp |
| 8 | Kicker connector hub saver |
| 9 | Kicker branch pipe inlet |
| 10 | Pig housing |
| 11 | Main connector |
| 12 | Main connector clamp |
| 13 | Main connector hub saver |
| 14 | End closure |
| 15 | Bypass valve X-over |
| 16 | Pig lock |
| 17 | Flushing bypass branch |
| 18 | Pig |
| 19 | Poppet valves |
| 20 | Main frame |
| 21 | Rear landing foot |
| 22 | Drop protection |
| 23 | Guide pins |
| 24 | Pig detector |
| 25 | Subsea control module fluid ports |
| 26 | Kicker header connection |
| 27 | Kicker piping connections |
| 28 | |
| 29 | |
| 30 | Dual header, subsea hydrocarbon production manifold |
| 31 | Jumpers |
| 32 | Pipelines |
| 33 | Manifold headers |
| 34 | Subsea control module (SCM) |

1-15. (canceled)

16. A pig launcher comprising a tubular pig housing adapted to hold a number of pigs arranged in a line, and a kicker branch pipe inlet for each of the number of pigs spaced along a longitudinal axis of the tubular pig housing;
a main connector connectable to a fluid flow line at an end of the tubular pig housing;
a kicker valve for each of the number of pigs, each kicker valve including a control pressure inlet, a flow inlet and a flow outlet;
a kicker valve control pipe connected to the control pressure inlet on each of the kicker valves and to a kicker system connector;
a kicker header connected to the flow inlet of each of the kicker valves; and a kicker branch pipe connected between the flow outlet of each of the kicker valves and the kicker branch pipe inlet for each of the number of pigs.

17. The pig launcher of claim 16, wherein each kicker valve control pipe and the kicker header is connected to one single kicker system connector for all the kicker valve control pipes.

18. The pig launcher of claim 16, wherein the kicker header is connected to the kicker system connector.

19. The pig launcher of claim 16 further including a flushing bypass branch with a bypass valve between an inlet end of the kicker header and an outlet end of the tubular pig housing.

20. The pig launcher of claim 16 wherein the kicker system connector includes a fluid coupler with a poppet valve for each of the kicker valve control pipes.

21. The pig launcher of claim 16 further including a kicker connector hub saver with a hub connector at a first end connected to the kicker system connector and a kicker connector hub saver hub at a second end.

22. The pig launcher of claim 21, wherein the kicker connector hub saver includes a fluid coupler with a poppet valve for each of the kicker valve control pipes on at least one of the first end and the second end.

23. The pig launcher of claim 16 further including a main connector hub saver with a hub connector at a first end connected to the main connector and a main connector hub saver hub at a second end.

24. The pig launcher of claim 16 further including a pig lock in the pig housing between a connection between a flushing bypass branch and the tubular pig housing, and a connection between the tubular pig housing and a kicker branch pipe.

25. The pig launcher of claim 16, wherein the number of pigs the pig housing is adapted to hold corresponds to the number of kicker valves.

26. The pig launcher of claim 25, wherein the number of pigs the pig housing is adapted to hold and the number of kicker valves is six.

27. The pig launcher of claim 16, adapted to be installed on a seabed with a longitudinal axis of the pig housing horizontally.

28. A pig launching system with a pig launcher of claim 16, further including a subsea control module with a subsea control module fluid port for each of the kicker valve control pipes in fluid connection with the kicker system connector.

29. Use of a pig launcher according to claim 16 to launch at least one pig into a fluid flow containing pipeline.

30. A subsea production field comprising at the pig launcher according to claim 16.
